(19) United States
(12) Patent Application Publication
(10) Pub. No.: US 2016/0061394 A1
(43) Pub. Date: Mar. 3, 2016

(54) STAND-TYPE LED LIGHTING DEVICE

(71) Applicant: KMW INC., Hwaseong (KR)

(72) Inventors: Jin-Soo Yeo, Hwaseong (KR); Min-Soo Kim, Hwaseong (KR)

(73) Assignee: KMW INC.

(21) Appl. No.: 14/934,853

(22) Filed: Nov. 6, 2015

Related U.S. Application Data
(63) Continuation of application No. PCT/KR2014/004114, filed on May 8, 2014.

(30) Foreign Application Priority Data
May 8, 2013 (KR) 10-2013-0051844

(51) Int. Cl. F21S 6/00; F21V 29/74

(52) U.S. Cl. CPC F21S 6/005; F21V 29/74; F21Y 2101/02

(57) ABSTRACT

The present invention relates to a stand-type LED lighting device comprising: a stand part; a support part fixed to the stand part and extending upwards; and a lighting part fixed to the upper part of the support part and emits light, wherein the lighting part comprises: an inclined reflective plate; an upper lighting part positioned above the reflective plate; and a lower lighting part positioned below the reflective plate. In the present invention, the lighting part is divided into the upper and lower lighting parts, and the reflective plate is provided between the upper and lower lighting parts so as to enable each or both of the upper lighting part and the lower lighting part to be used according to a user's selection, thereby enabling the stand-type LED lighting device to be used as a room lighting lamp or a mood lamp, in accordance with circumstances.

### CROSS REFERENCE TO RELATED APPLICATIONS

This application is a continuation of International Application No. PCT/KR2014/004114 filed on May 8, 2014, which claims priority to Korean Application No. 10-2013-0051844 filed on May 8, 2013, which application is incorporated herein by reference.

### TECHNICAL FIELD

The present invention relates to a stand-type LED lighting device, and more specifically, to a stand-type LED lighting device that allows for random selection of its lighting direction and that has excellent heat dissipation characteristics.

### BACKGROUND ART

Generally, indoor lighting installed in a confined space provides a lower brightness than that of outdoor lighting. Thus, indoor lighting adopts indirect lighting via a reflective plate rather than direct lighting. That is, indoor lighting is required to light up the room while, if possible, avoiding from directly shining the user's eyes. Indoor lighting is sometimes installed on the ceiling or wall, but other times comes in a stand-type for partial illumination or decoration.

Recently, stand-type lights are being developed for better interior designs while serving as mood lighting as well as indoor lighting, and effective indoor lighting is required to create various atmospheres.

Further, there is in development indoor lighting technology that adopts LEDs that are lower-power consumption, long-lifespan, and more eco-friendly light sources as compared with existing incandescent lamps or fluorescent lamps.

Basically, LEDs may emit light of various illuminances and colors depending on settings, but due to difficulties in settings for home use, they are mostly manufactured to provide a single color of light, like white or daylight color.

Indoor lamps employing single color-emissive LEDs cannot achieve an enhanced decoration effect that is something more than mere lighting, and thus fail to live up to the market demand.

Conventional stand-type LED lighting devices are configured to primarily provide downlighting for table use. An example of providing uplighting is disclosed in Korean Utility

Model Application Publication No. 20-2010-0013001. As per the Koran Utility Model Application Publication, uplighting is provided to create some patterns, like constellation, on the ceiling and its structure fails to provide uplighting and downlighting depending on the user's selection.

In other words, it cannot simultaneously provide downlighting and mood lighting.

### SUMMARY

To address the above problems, an object of the present invention is to provide a stand-type LED lighting device that includes main lighting, which is oriented downwards, and mood lighting, which is oriented upwards, that may be selected by the user for illumination.

Further, there is provided a stand-type LED lighting device in which uplighting and downlighting may be clearly differentiated. Light from the uplighting may evenly scatter rather than focusing on the ceiling in the room, allowing an aesthetic effect.

Further, according to the present invention, there is provided a stand-type LED lighting device that may effectively dissipate heat from the LEDs.

To achieve the above objects, according to the present invention, a stand-type LED lighting device comprises a base, a support fixed to the base and extending upwards, and a lighting part fixed to an upper portion of the support and diffusing light, wherein the lighting part includes a reflective plate that is an inclined surface, an upper lighting part positioned over the reflective plate, and a lower lighting part positioned under the reflective plate.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a cross-sectional view illustrating a stand-type LED lighting device according to a preferred embodiment of the present invention.

FIG. 2 is an exploded perspective view illustrating a lighting part according to the present invention.

FIG. 3 is a cross-sectional view illustrating in detail a portion of a lower lighting part according to the present invention.

FIG. 4 is a cross-sectional view illustrating in detail a portion of an upper lighting part according to the present invention.

FIG. 5 is a cross-sectional view illustrating a stand-type LED lighting device according to another embodiment of the present invention.

### DETAILED DESCRIPTION

Hereinafter, a stand-type LED lighting device according to the present invention is described in detail with reference to the accompanying drawings.

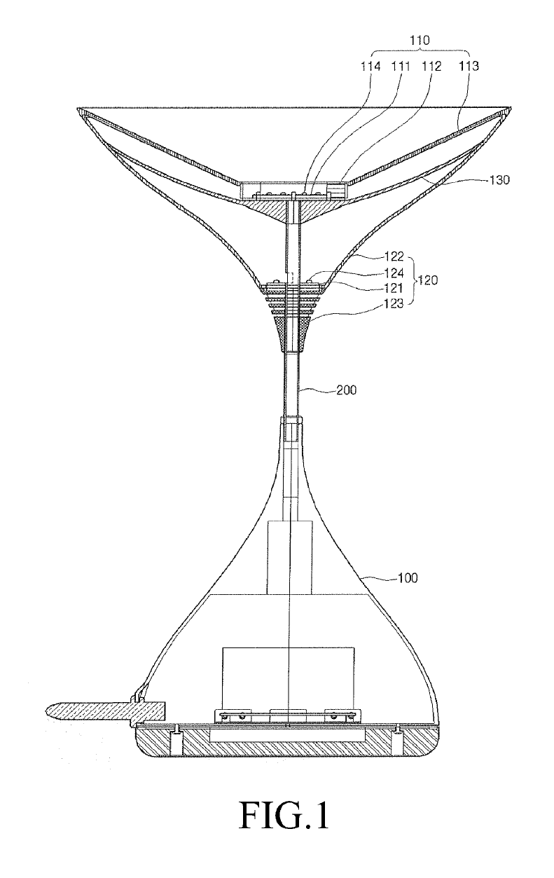

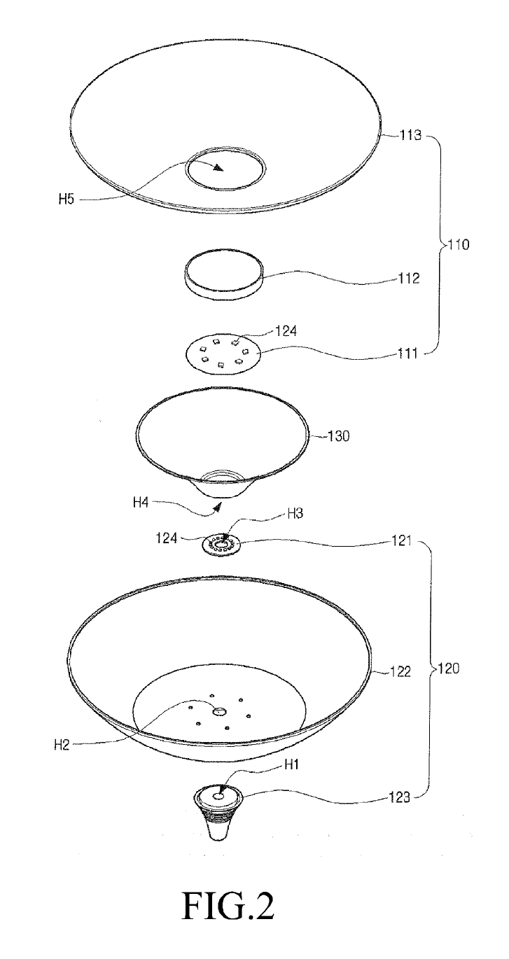

FIG. 1 is a cross-sectional view illustrating a stand-type LED lighting device according to a preferred embodiment of the present invention. FIG. 2 is an exploded perspective view illustrating the lighting part 100 of FIG. 1.

Referring to FIGS. 1 and 2, there are included a lighting part 100 including a reflective plate 130 inside an upper lighting part 110 and a lower lighting part 120, a support 200 extending downwards from the center of a lower portion of the lighting part 100, and a base 300 having an upper portion connected with the support 200 to stand the lighting part 100 up and receiving a power supply and a control circuit therein.

The lower lighting part 120 includes a lower substrate 121 having a hole H3 at the center thereof, through which the support 200 is inserted, and over which multiple LEDs 124 are arranged, a light-transmissive cover 122 receiving the lower substrate 121 in a lower portion thereof and allowing light reflected by the reflective plate 130, which reflects light from the LEDs 124, to be scattered to the outside, and a heat-dissipating member 123 coupled with a lower portion of the light-transmissive cover 122 and providing a seating surface on which the lower substrate 121 is seated to dissipate heat from the LEDs 124.

The light-transmissive cover 122 has a cylindrical structure with a narrower top and a broader bottom. At the center of a lower portion of the light-transmissive cover 122 is prepared a hole H2 through which the support 200 is inserted and that diffuses light reflected by the reflective plate 130 to produce surface light emission.

The upper lighting part 110 includes a side-surface light emitting part 112 that is positioned at an upper portion of the center of the reflective plate 30 to emit light to the side surface, an upper plate 111 having multiple LEDs 114 and installed in the side-surface light emitting part 112, and an upper diffusing part 113 having a hole H5 at the center thereof to allow for coupling of a portion of an upper portion of the side-surface light emitting part 112, shaped in structure as a disc that rises up to the edge, and diffusively scattering light emitted from the side surface of the outlet 12 and light reflected on the top surface of the reflective plate 130.

Hereinafter, the configuration and operation of the stand-type LED lighting device configured as above are described in greater detail according to a preferred embodiment of the present invention.

First, the support 200 uses a metal pipe and allows electric wires to pass therethrough to supply power to the lower substrate 121 and the upper substrate 111. The support 200 also plays a role to conduct and dissipate heat generated from the lower substrate 121 and the upper substrate 111.

A lower end of the support 200 is fixed to an upper portion of the base 300, and an upper end thereof is inserted passing through the lighting part 100.

The lower substrate 121, the light-transmissive cover 122, and the light-dissipating member 123 constituting the lower lighting part 120, which is a lower side of the lighting part 100, have the holes H3, H2, and H1, respectively, through which the support 200 is inserted. The hole H2 of the light-transmissive cover 122 is configured so that the upper portion of the light-dissipating member 123 is partially inserted through the hole H2, and the lower substrate 121 is positioned abutting the upper portion of the light-dissipating member 123.

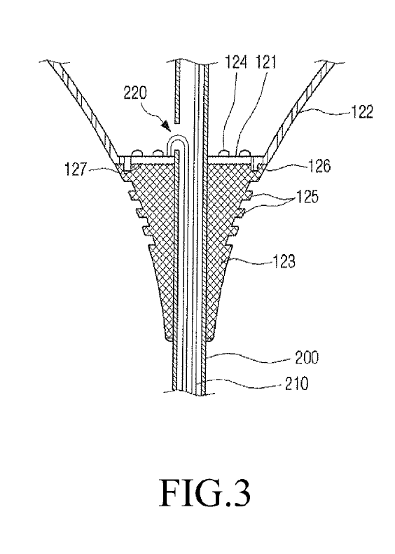

FIG. 3 is a cross-sectional view illustrating in detail a portion of a lower lighting part 120.

Referring to FIG. 3, on an upper side of the light-dissipating member 123 is prepared a seating surface 127 where the lower substrate 121 is seated. A coupling cut 126 is prepared along the periphery of the seating surface 127. The coupling cut 126 is a cut where the lower end of the light-transmissive cover 122 is inserted and where the light-dissipating member 123 and the light-transmissive cover 122 are joined together.

The support 200 passes through the light-dissipating member 123 and the lower substrate 121. A through hole 220 is prepared in the lower substrate 121 which is seated on the seating surface 127 of the light-dissipating member 123 to connect electric wires.

When the multiple LEDs 124 prepared on the lower substrate 121 as configured above are supplied power to emit light, the LEDs 124 may generate heat. The generated heat is transferred to the light-dissipating member 123 and is discharged out while heat-exchanging with the external air. Here, multiple heat-dissipating fins 125 are prepared on the outer side of the light-dissipating member 123 to facilitate heat dissipation.

Referring back to FIGS. 1 and 2, light emitted from the LEDs on the lower substrate 121 is directed upwards and is reflected on the bottom of the reflective plate 130.

Here, the reflective plate 130 is shaped so that its center is positioned lower while its edge is positioned higher and the bottom of the reflective plate 130 becomes a reflecting surface whose center projects downwards.

Accordingly, light reflected on the bottom of the reflective plate 130 is dispersed externally and is discharged out through the light-transmissive cover 122. Here, the light-transmissive cover 122 may be formed of a transparent material that fully transmits the reflected light or may be formed of a translucent material that allows the light-transmissive cover 122 itself to reflect light to produce a surface light emission.

The upper end of the support 200 is inserted through the hole H4 prepared in the reflective plate 130 and is then positioned inside the reflective plate 130. At the center of the upper portion of the reflective plate 130 is seated and fixed the side-surface light emitting part 112 of the upper lighting part 110.

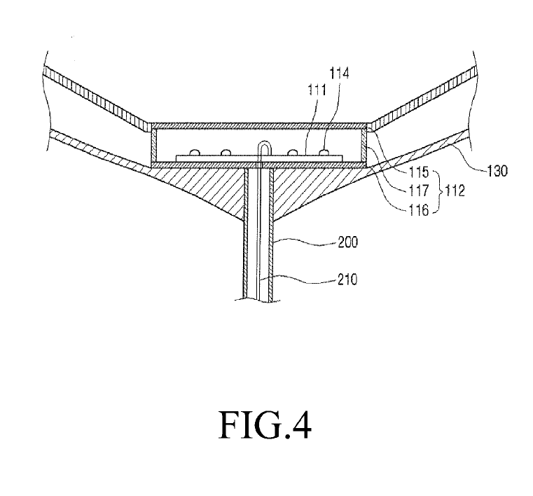

FIG. 4 is a cross-sectional view illustrating in detail a portion of an upper lighting part 110 according to the present invention.

Referring to FIG. 4, the side-surface light emitting part 112 of the upper lighting part 110 is a disc having an upper plate 115 and a lower plate 116 each formed of a metal and a cylindrical side-surface diffusing plate 117 between the upper plate 115 and the lower plate 116.

The lower plate 116 of the side-surface light emitting part 112 is coupled and fastened to the upper end of the support 200, and the upper substrate 111 is positioned inside the side-surface light emitting part 112. As shown in the drawings, the upper substrate 111 is seated on the lower plate 116 and may have multiple LEDs 114 mounted on the upper surface thereof. Here, heat emitted from the LEDs 114 are dissipated through the lower plate and dissipated through the reflective plate 130 abutting the bottom of the lower plate 116.

As such, the reflective plate 130 may prevent light interference between the upper lighting part 110 and the lower lighting part 120 and may be used as heat dissipating means to easily draw out the heat generated from the LEDs 114 of the upper substrate 111.

As such, heat dissipation may be easily done using the reflective plate 130. Further, heat may be conducted through the support 200, which is formed of a metal, and is then dissipated through the light-dissipating member 123 while also conducted and dissipated through the monitor 300. Therefore, better heat dissipation may be achieved.

The upper substrate 111 is not required to have such a structure as shown in the drawings, and for better side surface emission, it may be disposed so that the light emission surface of the LEDs 114 face the side surface.

Light emitted from the LEDs 114 of the upper substrate 111 in the side-surface light emitting part 112 comes out only through the side-surface diffusing plate 117, and the coming-out light is reflected on the top of the reflective plate 130 and diffused by the upper diffusing part 113 to the outside.

Such configuration of the upper lighting part 110 presents no direct light emission to the ceiling in the room and rather creates an ambient atmosphere of lighting through the side-surface diffusing plate 117 and the upper diffusing part 113. Accordingly, the upper lighting part 110 may be used as a mood lamp.

In the case where power is supplied only to the upper substrate 111 of the upper lighting part 110, light from the upper lighting part 110 is not radiated towards the lower lighting part 120 by the reflective plate 130, and even when power is supplied only to the lower substrate 121 of the lower lighting part 120, light from the lower lighting part 120 does not influence the upper lighting part 110 due to the reflective plate 130.

Even when power is supplied to both the upper substrate 111 and the lower substrate 121, light beams respectively from the upper lighting part 110 and the lower lighting part 120 are diffused, split up and down.

Accordingly, making the color of the upper diffusing part 113 of the upper lighting part 110 different from the light-transmissive cover 122 of the lower lighting part 120 may create various atmospheres.

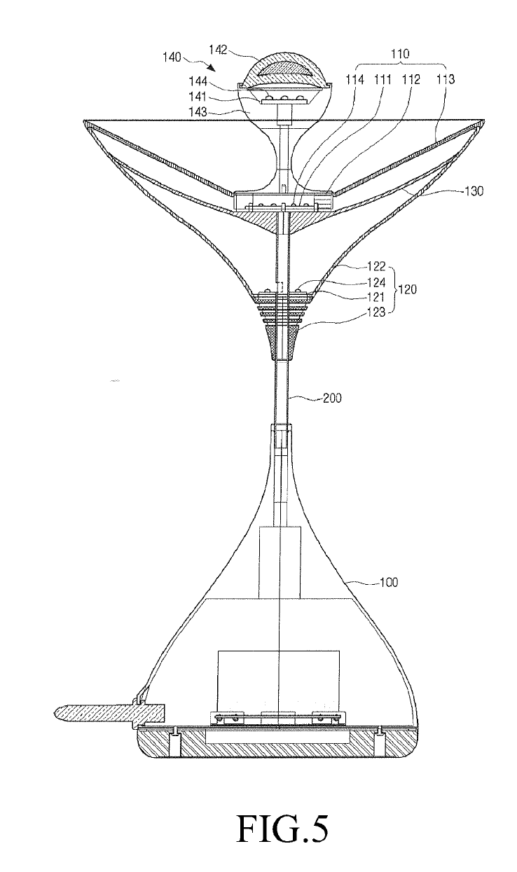

FIG. 5 is a cross-sectional view illustrating a stand-type LED lighting device according to another embodiment of the present invention.

Referring to FIG. 5, the stand-type LED lighting device according to another embodiment of the present invention includes a bulb lighting part 140 in addition to the same configuration given for the stand-type LED lighting device described above in connection with FIGS. 1 to 4 according to a preferred embodiment of the present invention.

The bulb lighting part 140 includes a body 143 having a lower end fixed to the top of the upper plate 115 of the side-surface light emitting part 112 and an upper end extending upwards and positioned higher than the edge of the upper diffusing part 113, a substrate 141 received in the hole prepared at the center of the top of the body 143, multiple LEDs 144 mounted on the upper portion of the substrate 141, and a lens 142 covering the top of the body 143.

The bulb lighting part 140 is illumination for creating an atmosphere and may produce various atmospheres depending on the color or function of the lens 142. When the lens 142 is designed so that light is collected to an inside of the lens 142, light may be concentrated on the light collected portion, thereby leading to more splendid illumination. This may serve as point illumination in addition to the ambient atmosphere created by the upper lighting part 110.

The body 143 is formed of a metal and plays a role to dissipate heat from the LEDs 144.

As such, the stand-type LED lighting device according to the present invention may create various types of illumination by preventing light interference between the upper lighting part 110 and the lower lighting part 120 and may effectively dissipate heat from the LEDs to prevent LED lifespan from shortening.

It is apparent to one of ordinary skill in the art that the present invention is not limited to the embodiments described above and various changes or modifications may be made thereto without departing from the scope of the present invention.

In the stand-type LED lighting device according to the present invention, the lighting part is divided into the upper lighting part and the lower lighting part. The reflecting part is provided between the upper lighting part and the lower lighting part. Thus, the upper lighting part and the lower lighting part each may be used by the user's selection. Further, the upper lighting part and the lower lighting part may be rendered simultaneously used so that they may be used for indoor lighting or mood lighting as necessary.

Further, the present invention may prevent light interference between the lower lighting part and the upper lighting part by the reflective plate, enabling the main light to be used separately from the mood light.

Further, according to the present invention, heat generated from the LEDs in the upper lighting part and the lower lighting part may be drained out through the support, preventing the lifespan of the LEDs from shortening.

What is claimed is:

1. A stand-type LED lighting device, comprising a base, a support fixed to the base and extending upwards, and a lighting part fixed to an upper portion of the support and diffusing light, wherein the lighting part includes a reflective plate that is an inclined surface, an upper lighting part positioned over the reflective plate, and a lower lighting part positioned under the reflective plate.

2. The stand-type LED lighting device of claim 1, wherein the reflective plate provides an inclined surface having a center positioned lower and an edge positioned higher.

3. The stand-type LED lighting device of claim 1, wherein the lower lighting part and the reflective plate have a hole through which the support is inserted.

4. The stand-type LED lighting device of claim 1, wherein the lower lighting part includes:
a heat-dissipating member inserted to a middle portion of the support;
a lower substrate having multiple LEDs mounted thereof and seated on an upper surface of the heat-dissipating member; and
a light-transmissive cover whose end is inserted and fixed to a coupling cut prepared at the periphery of the lower substrate and drawing light reflected on a lower surface of the reflective plate to an outside.

5. The stand-type LED lighting device of claim 4, wherein the light-transmissive cover has a cylindrical structure whose diameter increases upwards and is formed of a transparent or translucent material.

6. The stand-type LED lighting device of claim 4, wherein the heat-dissipating member is formed of a metal and includes a seating surface where the lower substrate is seated, the coupling cut prepared along the edge of the seating surface, and multiple heat-dissipating fins prepared on an outer surface.

7. The stand-type LED lighting device of claim 1, wherein the upper lighting part includes:
an upper substrate having multiple LEDs mounted thereon;
a side-surface light emitting part receiving the upper substrate and emitting light from the LEDs of the upper substrate to a side surface; and
an upper diffusing part diffusing and drawing out light that is emitted from the side-surface light emitting part and is reflected on an upper surface of the reflective plate.

8. The stand-type LED lighting device of claim 7, wherein the side-surface light emitting part is seated and fixed to a center of an upper portion of the reflective plate.

9. The stand-type LED lighting device of claim 7, wherein the side-surface light emitting part includes a metallic upper plate, a lower plate having an upper surface where the upper substrate is seated, and a side-surface diffusing plate positioned at the periphery between the upper plate and the lower plate to draw light from the upper substrate to a side surface.

10. The stand-type LED lighting device of claim 9, wherein the lower plate is fixed abutting a center of an upper portion of the reflective plate to transfer heat from the upper substrate to the reflective plate to thereby draw out the heat.

11. The stand-type LED lighting device of claim 1, further comprising: a bulb lighting part extending from the upper lighting part and positioned higher than the upper lighting part.

12. The stand-type LED lighting device of claim 11, wherein the bulb lighting part includes a metallic body fixed to an upper portion of the upper lighting part and extending upwards, a substrate having multiple LEDs mounted thereof and received in a hole prepared in an upper surface of the body, and a lens covering the upper surface of the body.

13. The stand-type LED lighting device of claim 9, further comprising: a bulb lighting part extending upwards from the upper surface of the upper plate and positioned higher than the edge of the upper diffusing part.

14. The stand-type LED lighting device of claim 13, wherein the bulb lighting part includes a metallic body fixed to an upper portion of the upper plate and extending upwards, a substrate having multiple LEDs mounted thereof and received in a hole prepared in an upper surface of the body, and a lens covering the upper surface of the body.
